(19) United States
(12) Patent Application Publication
(10) Pub. No.: US 2004/0037754 A1
(43) Pub. Date: Feb. 26, 2004

(54) Apparatus for the removal of soot particles from the exhaust gas of diesel engines

(76) Inventors: Barry van Setten, Rodenbach (DE); Marcus Pfeifer, Solingen (DE); Jurgen Gieshoff, Biebergemund (DE); Egbert Lox, Hochwaldhausen (DE); Thomas Kreuzer, Karben (DE)

Correspondence Address: KALOW & SPRINGUT LLP, 488 MADISON AVENUE, 19TH FLOOR, NEW YORK, NY, 10022, US

(21) Appl. No.: 10/616,744

(22) Filed: Jul. 9, 2003

(30) Foreign Application Priority Data
Aug. 23, 2002 (DE) 10238770.2

(51) Int. Cl. B01D 53/34

(52) U.S. Cl. 422/177; 55/523

(57) ABSTRACT

The present invention is directed to the removal of soot particles from the exhaust of a diesel engine. A device is provided that comprises a wall-flow filter having inflow channels and outflow channels, which are connected by pores. Preferably the inflow channels and outflow channels are alternately closed on opposite sides. The flow channels that are closed on the outflow side form the inflow channels and the flow channels that are closed on the inflow side form the outflow channels of the filter. In the inflow channels and/or the outflow channels of the filter, exhaust treatment structures are provided. The walls of the flow channels, as well as the exhaust treatment structures, are preferably coated with a catalyst layer. Since the exhaust does not need to flow through these exhaust treatment structures, the catalyst deposited thereon is not covered by soot. The filter function and the catalytic function of the catalyst layer on the exhaust treatment structures are thus largely separated from one another. Advantageously, the different functions complement one another, so that a high degree of efficiency in the exhaust treatment is achieved despite the small mounting volume required by the inventive device.

### FIELD OF INVENTION

The present invention relates to the removal of soot particles from the exhaust of a diesel engine.

### BACKGROUND OF INVENTION

For 2005, the European Union plans to tighten motor vehicle emission standards. To meet these standards, one will need to achieve a simultaneous reduction of nitrogen oxide and soot emissions in newly developed exhaust emission control systems. Unfortunately, any structural measures on diesel engines to lower one of the two emission components causes a simultaneous increase in the other emission component.

For instance, if soot emissions are lowered by increasing the combustion temperature in a diesel engine, more nitrogen oxides are formed. If on the other hand the emission of nitrogen oxides is reduced, for instance by exhaust gas recirculation, the soot emission is increased. Thus, the current structural measures for optimizing diesel engines represent a compromise between optimizing soot emissions and optimizing nitrogen oxide emissions.

To reduce or to eliminate soot emissions, filters, particularly wall-flow filters, are used. Such filters achieve filtration efficiencies of more than 95%, which ensures an efficient reduction of soot emissions in the exhaust of a diesel engine. Unfortunately, such filters become clogged by the continuous deposition of soot particles. Consequently, these filters must be regenerated by burning the soot particles.

In principle, the filters can be regenerated by thermal methods; the soot particles can be burned with the aid of oxygen present in the exhaust. However, this type of thermal combustion requires temperatures ranging from 550° C. to 600° C., and such temperatures are obtained in the exhaust of a diesel engine only if the diesel engine is operated at full load. Thus, under currently practiced techniques, regenerating the filter during normal operation is possible only if the filter is heated by additional means. This requires more energy and increases fuel consumption.

For example, British Patent Specification GB 2,134,407 A describes a system of a particulate trap with an upstream oxidation catalyst. To regenerate the filter, the content of unburnt fuel in the exhaust is periodically increased. The additional fuel is burnt on the oxidation catalyst with the release of heat, and the downstream particulate trap is thereby heated to the regeneration temperature. The additional oxygen required for combustion in this system can be supplied to the exhaust gas by means of compressed air.

Unfortunately, there are drawbacks to an exhaust system in which a catalyst and a filter trap are arranged as separate units, one behind the other in the exhaust stream. For example, this type of an arrangement requires an undesirably large mounting volume. In addition, such multi-arrangements produce a high exhaust counter-pressure as the exhaust flows through them. This in turn causes an undesirable increase in fuel consumption. Moreover, this problem is further aggravated because additional catalyst units are typically required to obtain satisfactory exhaust treatment.

Similar examples include units for reducing the nitrogen oxide or NOₓ content of the exhaust. These units can be configured as SCR (selective catalytic reduction) units or absorber units that are capable of absorbing NOₓ molecules. However, they too are less efficient than is desired.

Thus, there remains a need to develop more efficient means for treating exhaust gases. The present invention provides one solution to this problem.

### SUMMARY OF INVENTION

The present invention is directed to the removal of soot particles from the exhaust of diesel engines. According to the present invention, a wall-flow filter that has inflow channels and outflow channels permit the introduction of exhaust into the inflow channels, and forces it to exit though the outflow channels through the use of pores that connect the inflow channels and the outflow channels. Preferably, the inflow channels and outflow channels are closed on alternate ends to ensure that the exhaust gas passes through the pores on its way from the inflow channels to the outflow channels. Additionally, exhaust treatment structures for the treatment of exhaust gas are provided in the inflow channels and the outflow channels. Preferably, the inflow channels, the outflow channels and the exhaust treatment structures each have a catalyst coating.

In one embodiment, the present invention provides a device for removing soot particles from the exhaust of a diesel engine, wherein said device comprises of a wall-flow filter, and said wall-flow filter is comprised of:

(a) inflow channels;

(b) outflow channels, wherein said inflow channels and said outflow channels are connected by pores; and

(c) exhaust treatment structures, wherein said exhaust gas treatment structures are located in said inflow channels and/or in said outflow channels.

The present invention also comprises a process for removing soot particles from the exhaust of a diesel engine, said process comprising:

(a) exposing an exhaust gas to a wall-flow filter, wherein said wall-flow filter is comprised of:

(i) inflow channels;

(ii) outflow channels, wherein said inflow channels and said outflow channels are connected by pores; and

(iii) exhaust treatments structures, wherein said exhaust treatment structures are located in said inflow channels and/or in said outflow channels; and

(b) causing the exhaust gas to enter the wall-flow filter through said inflow channels and to leave the wall-flow filter through said outflow channels, wherein said inflow channels and said outflow channels are linked by pores.

### BRIEF DESCRIPTION OF THE FIGURES

FIG. 1 is a representation of a longitudinal section of a wall-flow filter.

FIG. 2 is a representation of a top view of a detail of the front of the wall-flow filter according to FIG. 1.

FIGS. 3 to 7 are top views of various wall-flow filters with differently configured exhaust treatment structures.

### DETAILED DESCRIPTION

The present disclosure is not intended to be a treatise on wall-flow filters or the treatment of exhaust gases in diesel engines. Readers are referred to appropriate available texts for additional background on these subjects.

In one embodiment, the present invention provides a device for removing soot particles from the exhaust of a diesel engine. The device is comprised of a wall-flow filter that has flow channels that are alternately closed on opposite sides. The flow channels that are closed on the outflow side form the inflow channels of the filter, and the flow channels that are closed on the inflow side form the outflow channels of the filter, such that the exhaust introduced into the inflow channels must flow through porous flow channel walls into the outflow channels and then out of the filter. Preferably, the wall-flow filter may comprise a multi-arrangement of inflow channels and outflow channels.

The device also contains “exhaust treatment structures” for the treatment of exhaust that may be located in the inflow channels and/or the outflow channels of the filter. The channel walls of the flow channels, as well as the exhaust treatment structures, are preferably provided with a catalyst coating, also referred to as a catalyst layer.

According to the present invention, the exhaust treatment structures in the flow channels of the wall-flow filter provide additional surface areas for applying the catalyst coating.

Thus, the filtering function of the porous channel walls and the catalytic function of the catalyst coating on the exhaust treatment structures are largely separated from one another. However, the different functions preferably complement one another, so that a high degree of efficiency in exhaust treatment is achieved despite the small mounting volume of the present invention.

To coat the wall-flow filter, preferably a coating dispersion containing catalytically active components for exhaust treatment is poured over it from the inflow side and/or from the outflow side. Methods for applying catalyst coatings are well-known to a person skilled in the art. In one embodiment, both the channel walls of the wall-flow filter and the surfaces of the exhaust treatment structures present in the flow channels are provided with the same coating. It is also possible, however, to coat the inflow channels and their exhaust treatment structures with one catalyst layer and the outflow channels and their exhaust treatment structures with a different catalyst layer.

The exhaust treatment structures can be any type of structures that are subsequently introduced into the flow channels of the inflow side and/or the outflow side of a finished wall-flow filter. Preferably, the exhaust treatment structures are flat. However, one or more different exhaust treatment structures may be arranged along the inflow channels and/or the outflow channels. These exhaust treatment structures can extend over the entire length or over partial areas of the inflow channels and/or the outflow channels of the wall-flow filter.

Preferably, however, the exhaust treatment structures are produced together with the filter element in a single process step, e.g., by extrusion. Thus, it will be advantageous to make the exhaust treatment structures and the wall-flow filter out of the same material. Preferred materials are ceramic materials, such as, for instance, cordierite, silicon carbide, aluminum oxide, silicon nitride, mullite or mixtures thereof.

A device according to the present invention can also be simply formed by combining a plurality of adjacent channels in a conventional wall-flow filter into an inflow channel or an outflow channel. The channel walls located in the interior of such an inflow channel or outflow channel would then form the exhaust treatment structures. Through partial removal of these channel walls, the exhaust treatment structures can be specifically modified.

As described above, and depending on the desired functionality, the device according to the present invention can be coated with any one or more than one different catalytically active layers. These may, for example, be catalysts for lowering the ignition temperature of the soot; oxidation catalysts for hydrocarbons, carbon monoxide, and nitrogen oxides; reduction catalysts for selective catalytic reduction (SCR); or absorption layers for nitrogen oxides. Surprisingly, it has been found that in a device of the present invention, the catalyst layer found on the exhaust treatment structures retains its full catalytic function irrespective of the amount of soot particles that are deposited on the channel walls.

Such an effect has previously only been possible by combining two separate units, where the unit arranged upstream relative to the exhaust gases was formed by a catalyst without filter action and the second unit by the particulate trap. The present invention now makes it possible to combine the two units into one, which results in a spatially compact device.

In one preferred embodiment of present invention, the catalyst layer contains catalytically active substances that oxidize the pollutants contained in the exhaust. By way of example, the pollutants may be hydrocarbons and/or carbon monoxide and/or nitrogen monoxide.

With such a coating, the particulate trap can be continuously regenerated. In this type of coating, the nitrogen monoxide contained in the exhaust is oxidized to nitrogen dioxide, which serves as an oxidizing agent for the soot particles deposited along the channel walls of the trap. When the soot particles are oxidized or burnt, the nitrogen dioxide is reduced again to nitrogen monoxide. The catalysts used for this purpose preferably contain noble metals as catalytically active substances, e.g., platinum, palladium, or rhodium, or metal oxides of base metals. The noble metals, too, can be present entirely or partially in higher oxidation states.

The catalytic substances used may include, but are not limited to, platinum and/or palladium that is applied in the form of fine nanocrystalline particles to metal oxides, such as, for instance, cerium oxides and/or cerium/zirconium mixed oxides and/or praseodymium oxides and/or aluminum silicates and/or aluminum oxides.

In other embodiments of the present invention, additional catalyst layers and/or storage layers may also be applied. Examples of such catalyst layers include, but are not limited to SCR catalysts, which are used for the selective catalytic reduction of nitrogen oxides, and frequently contain V₂O₅, WO₃, and TiO₂. Examples of storage layers include but are not limited to adsorbed layers for adsorbing nitrogen oxides.

Selective catalytic reduction is defined as the conversion of the nitrogen oxides contained in the exhaust with ammonia to nitrogen and water. This conversion takes place in the presence of oxygen. Ammonia forms the reducing agent and must be supplied to the exhaust in front of the catalyst; however, instead of starting with ammonia, precursor compounds that can be readily hydrolyzed to ammonia, e.g., carbonate, are frequently used.

As an alternative or in addition thereto, storage layers may also be applied to the exhaust treatment structures. Such storage layers can be embodied as NOₓ adsorber layers. Such NOₓ adsorber layers contain, in particular, alkaline-earth metals, such as barium, strontium, or calcium. Further, the catalyst layer may contain platinum on activated aluminum oxide.

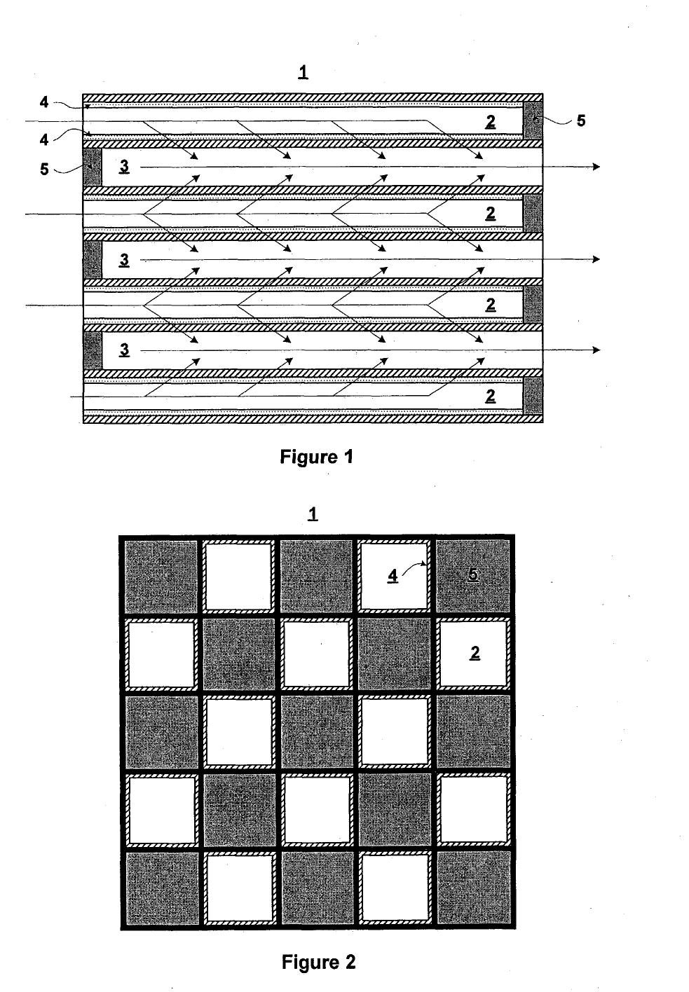

FIG. 1 shows a conventional wall-flow filter for eliminating soot particles from the exhaust of a diesel engine. The wall-flow filter, 1, has an alternating arrangement of inflow channels, 2, and outflow channels, 3. The inflow channels, 2, and outflow channels, 3, are separated from one another by channel walls that have a porous structure.

The interior walls of the inflow channels, 2, are coated with catalyst layers, 4. Further, the inflow channels, 2, are closed with seals, 5, on the outflow side. The outflow channels, 3, are closed with seals, 5, on the inflow side of wall-flow filter, 1.

The exhaust enters the inflow channels, 2, of the wall-flow filter, 1, as indicated by the arrows in FIG. 1, but cannot exit at the outflow-side ends of the inflow channels. Instead, the exhaust must flow through the porous channel walls with catalyst layers, 4, and then exit via the respectively adjacent outflow channels, 3, of wall-flow filter, 1. FIG. 2 shows a top view of the inlet side of the wall-flow filter of FIG. 1.

According to the present invention, the wall-flow filter, 1, depicted in FIG. 1 comprise exhaust treatment structures, 6, in the flow channels to permit additional treatment of the exhaust gases of a diesel engine. Examples of exhaust treatment structures are depicted in FIGS. 3 to 7. On these exhaust treatment structures, 6, catalyst layers, 4a, are deposited that are identical with catalyst layers, 4.

The catalyst layers, 4, and, 4a, may be deposited only on the walls of the inflow channels, 2, and the exhaust treatment structures contained therein. As an alternative or in addition thereto, the walls of the outflow channels, 3, and their exhaust treatment structures, if present, may also be coated with the catalyst layers, 4, and, 4a. Alternatively, as described above, in principle, the catalyst layers in the inflow channels and the outflow channels can differ from one another.

The exhaust treatment structures, 6, are preferably made of a ceramic material. Suitable for this purpose, in particular, are cordierite, aluminum oxide, silicon carbide, silicon nitride, mullite, or mixtures thereof. More preferably, the exhaust treatment structures, 6, are made of the same ceramic material as the filter body, 1.

The production of the exhaust treatment structures can be integrated in the production process of the filter body. Alternatively, the exhaust treatment structures can be produced separately from the filter body, coated with a catalyst, and subsequently be introduced into the filter body. In general, the present invention thus produced is configured in such a way that the exhaust treatment structures are spatially separate from the porous channel walls that filter the soot particles, such that particulate filtering and the exhaust treatment processes, which are carried out by means of the exhaust treatment structures as an additional functionality, are spatially separate from one another.

FIG. 3 shows an example of the present invention in which the exhaust treatment structures are produced during the production of a wall-flow filter, 1.

The wall-flow filter, 1, consists of a highly cellular wall-flow monolith having a large number of parallel channels. These channels may have identical square cross-sections. As may be seen from FIG. 3, four adjacent channels each are combined into one inflow channel, 2, which in turn has a square cross-section. The outflow channels, 3, preferably have the same structure.

The walls of the inflow channels, 2, form the boundary surfaces to the adjacent outflow channels, 3, through which the exhaust is guided from the inflow side to the outflow side of wall-flow filter, 1. The wall elements of the channels located in the interior of an inflow channel, 2, form the exhaust treatment structures, 6.

As may be seen from FIG. 3, the channel walls of the inflow channel, 2, are coated with a catalyst layer, 4, and the exhaust treatment structures 6 with a catalyst layer, 4a. Catalyst layers, 4, and, 4a, are identical.

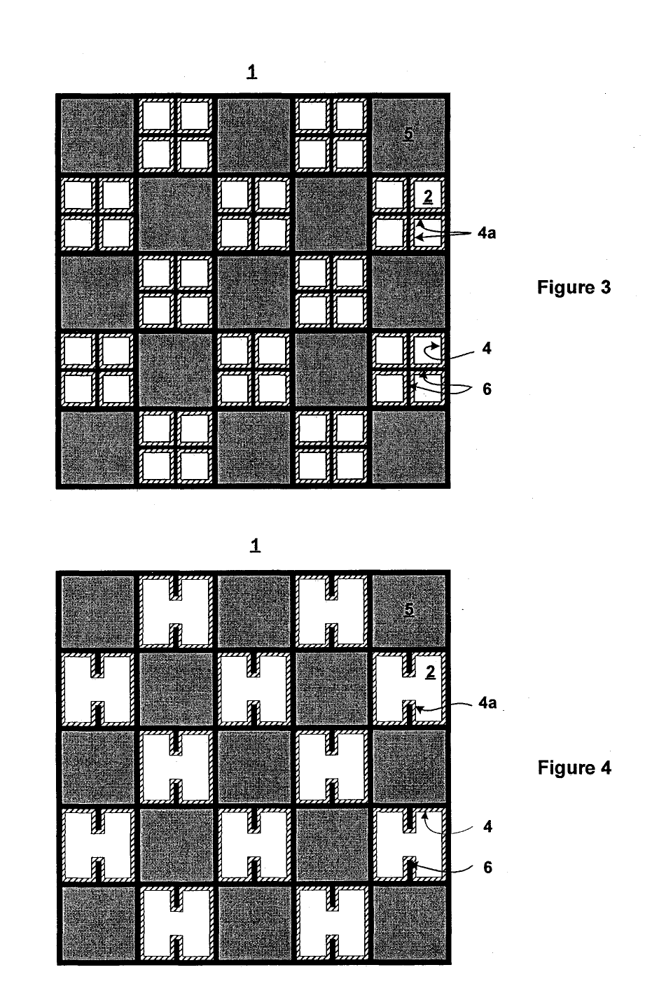

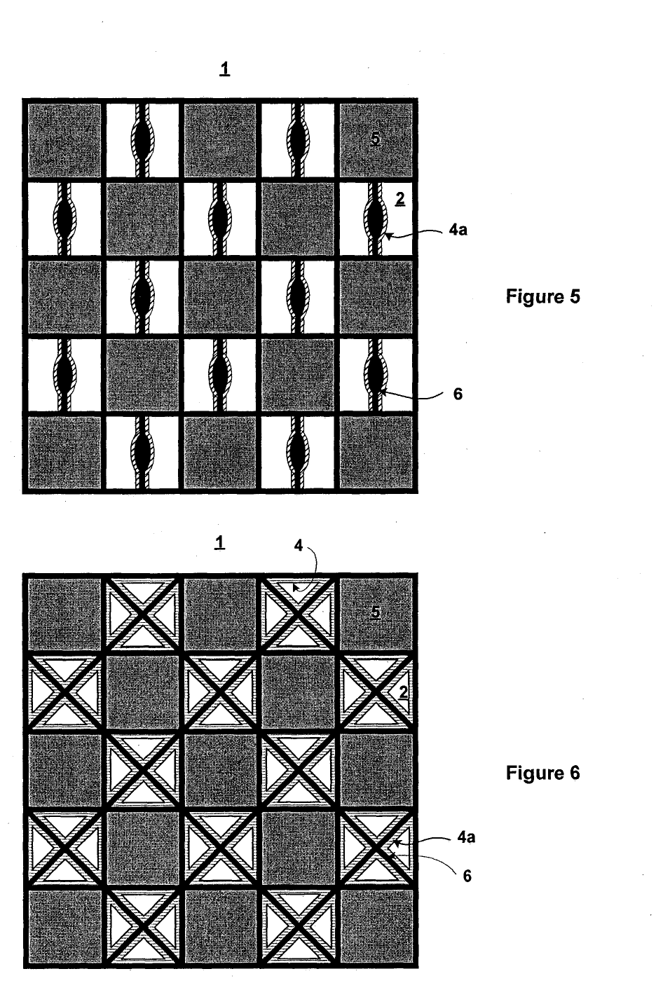

FIGS. 4 and 5 show further developments of the exemplary embodiment depicted in FIG. 3. The structure shown there is produced in the same manner as that depicted in FIG. 3. In contrast to the exemplary embodiment of FIG. 3, parts of the exhaust treatment structures are subsequently removed in the embodiment of FIG. 4. Catalyst layers, 4, of inflow channels, 2, and catalyst layers, 4a, of the exhaust treatment structures are again identical in the embodiment of FIG. 4.

FIG. 5 shows an exemplary embodiment with regularly formed wall-type exhaust treatment structures, 6. The walls forming the exhaust treatment structures, 6, are thicker in the center.

In general, the exhaust treatment structures in all of the examples shown can be limited to the discharge region of the inflow channels, 2, or outflow channels, 3. In the embodiment shown in FIG. 6, the concentration of the exhaust treatment structures can continuously vary over the length of an inflow channel, 2, or an outflow channel, 3. This variant, in particular, may depend on the production process of the exhaust treatment structures. In principle, it is also possible to provide different exhaust treatment structures over the length of an inflow channel, 2, or an outflow channel, 3.

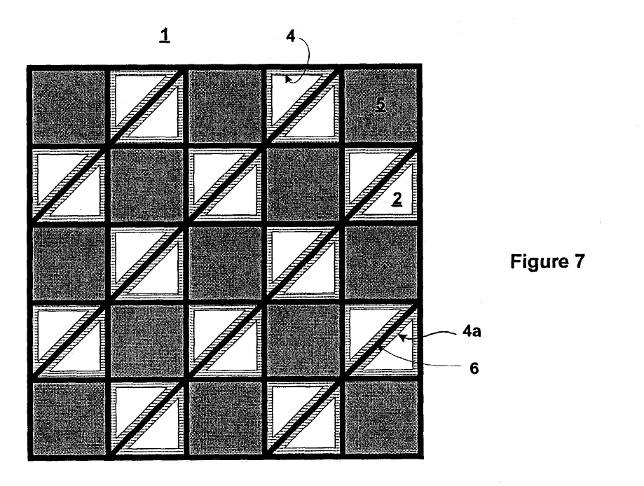

FIGS. 6 and 7 show further embodiments of regular exhaust treatment structures, 6, in the inflow channels, 2, and, outflow channels, 3, of a wall-flow filter, 1.

Having thus described and exemplified the present invention with a certain degree of particularity, it should be appreciated that the claims that follow are not to be so limited but are to be afforded a scope commensurate with the wording of each element of the claims and equivalents thereof.

1. A device for removing soot particles from exhaust of a diesel engine, wherein said device is comprised of a wall-flow filter, and said wall-flow filter is comprised of:
(a) inflow channels;
(b) outflow channels, wherein said inflow channels are connected to said outflow channels through pores; and
(c) exhaust treatment structures, wherein said exhaust treatment structures are located in said inflow channels and/or said outflow channels.

2. The device of claim 1, wherein said inflow channels, said outflow channels, and said exhaust treatment structures are coated with a catalyst layer.

3. The device of claim 1, wherein the wall-flow filter and the exhaust treatment structures are made of a ceramic material.

4. The device of claim 3, wherein said the ceramic material is selected from the group consisting of cordierite, silicon carbide, aluminum oxide, silicon nitride, mullite, and mixtures thereof.

5. The device of claim 4, wherein the exhaust treatment structures extend over the entire length or over partial areas of the inflow channels and/or the outflow channels.

6. The device of claim 5, wherein both the outflow channels and the inflow channels have exhaust treatment structures and the exhaust treatment structures of said inflow channels and said outflow channels are coated with a catalyst layer but the catalyst layer on said exhaust treatment structure of said outflow channels comprises a different substance than the catalyst layer on said exhaust treatment structure of said inflow channels.

7. The device of claim 1, wherein a plurality of adjacent channels of the wall-flow filter are combined into one inflow channel or one outflow channel, and wherein the combined adjacent channels have channel walls that are located in their interior that form the exhaust treatment structures.

8. The device of claim 2, wherein the catalyst layer comprises an oxidation catalyst.

9. The device of claim 8, wherein the oxidation catalyst comprises a carrier material selected from the group consisting of cerium oxide, cerium/zirconium mixed oxides, praseodymium oxide, aluminum silicate, active aluminum oxide, and mixtures thereof, to which platinum and/or palladium are applied in the form of nanocrystalline particles.

10. The device of claim 9, wherein the catalyst layer comprises a base metal.

11. The device of claim 2, wherein the catalyst layer comprises a catalyst for reducing the nitrogen oxides contained in the exhaust.

12. The device of claim 11, wherein the catalyst layer comprises an SCR catalyst.

13. The device of claim 12, wherein the SCR catalyst comprises V₂O₅, WO₃, or TiO₂, or mixtures of these compounds.

14. The device of claim 2, wherein the catalyst layer comprises components for absorbing nitrogen oxides contained in the exhaust.

15. The device of claim 14, wherein the components for absorbing the nitrogen oxides comprise at least one alkaline-earth metal.

16. The device of claim 15, wherein said alkaline-earth metal is selected from the group consisting of barium, strontium, and calcium.

17. The device of claim 16, wherein the catalyst layer further comprises platinum on activated aluminum oxide.

18. A process for removing soot particles from the exhaust of a diesel engine, said process comprising:
(a) exposing an exhaust gas to a wall-flow filter, wherein said wall-flow filter comprises:
(i) inflow channels;
(ii) outflow channels, wherein said inflow channels and said outflow channels are connected by pores; and
(iii) exhaust treatments structures, wherein said exhaust treatment structures are located in said inflow channels and/or in said outflow channels; and
(b) causing the exhaust gas to enter the wall-flow filter through said inflow channels and to leave the wall-flow filter through the outflow channels, wherein said inflow channels and said outflow channels are linked by pores, thereby removing soot through the wall-flow filter.
